(19) United States
(12) Patent Application Publication
(10) Pub. No.: US 2013/0016514 A1
(43) Pub. Date: Jan. 17, 2013

(54) DAZZLERS

(71) Applicants: Craig Daniel Stacey, Whitchurch (GB); David Wesley Charlton, Reading (GB)

(72) Inventors: Craig Daniel Stacey, Whitchurch (GB); David Wesley Charlton, Reading (GB)

(73) Assignee: BAE Syetems plc, London (GB)

(21) Appl. No.: 13/638,158

(22) PCT Filed: Mar. 23, 2011
(86) PCT No.: PCT/GB2011/050572

§ 371 Date: Sep. 28, 2012

(30) Foreign Application Priority Data
Mar. 31, 2010 (GB) 1005467.4

(51) Int. Cl. F21V 33/00

(52) U.S. Cl. 362/253

(57) ABSTRACT

A dazzler arrangement is disclosed in which the strength of the dazzle beam is modulated in accordance with the range of a target to be dazzled. A stray detection beam is transmitted alongside the dazzle beam to allow detection of a secondary object approaching or at the periphery of the dazzle beam, whereupon the dazzle beam is attenuated or inhibited.

### BACKGROUND TO THE INVENTION

This invention relates to dazzlers.

A dazzler is used to emit a beam of high intensity radiation, usually laser, towards a human or animal target temporarily to blind the target or to provide visual distraction or a warning. Typical existing dazzle lasers are of fixed power which places a lower limit on the nominal ocular hazard distance (that is the distance at which the laser becomes eye safe) and therefore the range over which the device is of use. This requires user judgment and, in order to have a practical minimum range, limits the laser power and therefore the upper range limit.

It is therefore an aim of this invention to provide a dazzle apparatus that at least mitigates the above shortcomings.

### SUMMARY OF THE INVENTION

Accordingly, in one aspect, this invention provides a dazzle apparatus comprising a radiation source for emitting a dazzle beam of radiation towards a target to be dazzled, the target being at a variable range, a beam control system to control the strength of the dazzle beam in accordance with the range of said target to deliver to said target radiation of sufficient intensity momentarily to dazzle a user, and a stray detector for detecting approach of a secondary object towards said dazzle beam, or vice versa and, in response to such approach, to reduce the strength of or inhibit the beam.

In this manner, the dazzle apparatus modulates the strength of the radiation to ensure that the beam is effective to dazzle the target without causing permanent ocular damage, thereby potentially increasing the range over which the dazzler may be effectively used and prevents inadvertent incidence of the dazzle beam on a secondary target which moves towards the dazzle beam or towards which the dazzle beam moves.

Although the emitter may emit intense visible non-coherent light, it is preferred for the emitter to emit a beam of coherent light such as laser radiation.

The device may receive target range data from an external device or more preferably from a range finder associated with the dazzler. The range finder may conveniently be a laser range finder. The range finder may use reflections of the dazzle laser suitably attenuated if required to determine the range of the target, or it could use a separate laser.

The beam control may adjust the strength of the beam by adjusting the source power, by attenuating the beam using e.g. an acousto-optic modulator, or it may adjust the strength of the beam by adjusting the divergence of the beam so as to adjust the intensity or laser power per unit area. The divergence of the beam of radiation may be adjusted by means of an adjustable beam expander.

The stray detector may include a stray detection beam source for emitting at least one stray detection beam to illuminate an area adjacent said dazzle beam and a stray detection receiver for detecting and processing radiation reflected by said at least one secondary object to determine a position of the secondary object relative to the dazzle beam. Preferably the stray detector source includes a beam shaper whereby the stray detector beam has a flattened shape in which the beam divergence in one plane is similar to that of the dazzle beam and is significantly greater in a perpendicular plane. The beam shaper may be a lens or grating. In addition or alternatively, said stray detector source may emit a plurality of stray detector beams each disposed to illuminate a respective area adjacent said dazzle beam. These may be from a single source or a plurality of sources. In another arrangement said stray detector source may be operable to scan one or more stray detector beams across an area adjacent the dazzle beam.

In an adaptive version, the stray detector may be operable to track the position of a secondary object and to predict the trajectory thereof, with said beam control system being operable to reduce the strength of, or inhibit, the dazzle beam if the predicted trajectory passes through, or within a preset distance of, the dazzle beam.

Still further, the beam control system may be operable also to control the angular position of the dazzle beam, and may include a target tracker operable on acquisition or designation of a target to provide to said beam control system data to enable the beam control to lock the dazzle beam on the target. Conveniently the beam control also steers the stray detector beam and the range finder beam if these are separate.

According to another aspect, this invention provides a dazzle apparatus comprising a radiation source for emitting a dazzle beam to dazzle a target, a stray detector for monitoring an area near said dazzle beam and for inhibiting or reducing the strength of said dazzle beam, on detecting a secondary object adjacent the periphery of said dazzle beam.

Whilst the invention has been described above it extends to any inventive combination of the features set out above, or in the following description, claims or drawings.

### BRIEF DESCRIPTION OF THE DRAWINGS

The invention may be performed in various ways, and various embodiments thereof will now be described by way of example only, reference being made to the accompanying drawings in which:

FIG. 1 is a schematic diagram of a laser dazzler in accordance with this invention with provision to control the strength of the radiation incident on a target to ensure momentary dazzling but without causing permanent ocular damage and also with a stray detection system designed to ensure that the dazzle beam is reduced or inhibited should a secondary object, other than the target, approach the dazzle beam;

FIG. 2 is a schematic diagram of operation of the device showing continuous range monitoring and corresponding control of dazzle power, and

FIG. 3 is a schematic diagram of operation showing the stray detector system employing one or more secondary stray detection beams to detect objects at or approaching the periphery of the dazzle laser.

### DESCRIPTION OF THE PRIOR ART

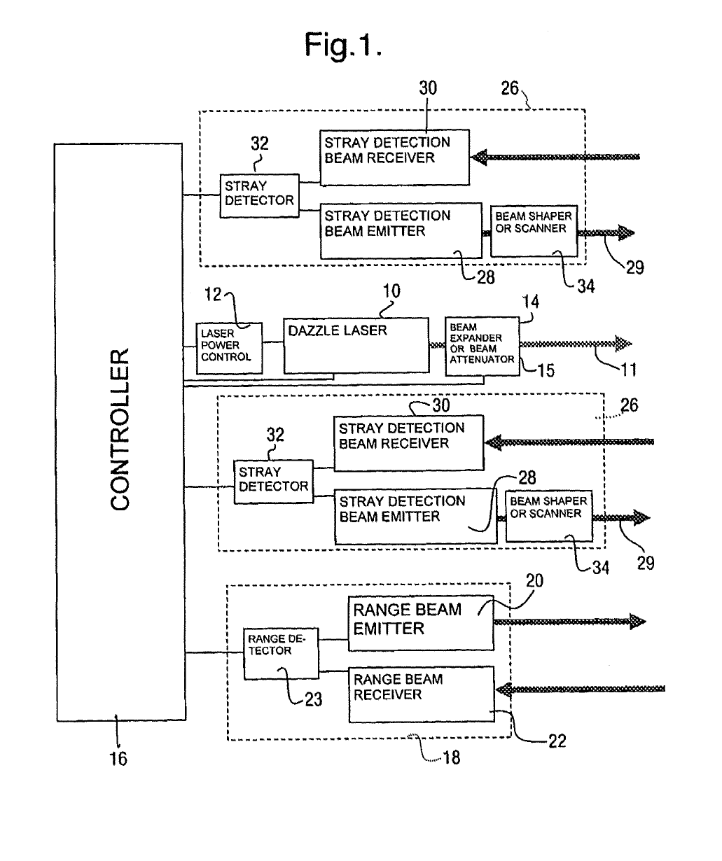

Referring initially to FIG. 1, the laser dazzle system comprises a dazzle laser 10 designed to emit a beam 11 of laser radiation designed to momentarily dazzle a human user. The strength of the laser beam (and in particular its intensity when received at the target) is adjustable by means of one or more of a power control unit 12, a beam attenuator modulator 14 and a variable beam expander 15, each being under the control of a central controller 16. A laser range finder generally indicated at 18 comprises a range beam emitter 20 and a range beam receiver 22 each under the control of a range detector 23 which receives and processes signals from the range beam receiver 22 to determine the range of a target. The laser range finder 18 is controlled by the central controller 16 which also receives range data from the range detector 23.

The apparatus also includes one or more stray detector modules indicated generally at 26 comprising a stray detection beam emitter 28 emitting a stray detection beam 29, and a stray beam detection receiver 30. The stray detection beam emitter and the stray beam detection receiver are each under the control of a stray detector 32 which controls them and processes the return information to identify when a stray secondary object is approaching the periphery of the beam emitted by the dazzle laser (or the periphery of the projected beam, if the dazzle laser is quiescent). The stray detector 26 supplies data relating to stray secondary objects to the controller and is also controlled by the controller 16. As to be described in more detail below, the stray detection beam emitter 28 is provided with a beam shaper or beam scanner unit 34.

Although the above embodiment includes a range beam emitter 22 and a stray detection beam emitter 28 separately from the dazzle laser 10, in modified embodiments one or both may be omitted and the dazzle laser controlled to provided a range finder facility and/or a stray detection facility. For example, operation of the dazzle laser 10 and the range finder 18 and stray detectors 26 may effectively be multiplexed with the dazzle laser intermittently being modified in at least one of laser wavelength, intensity, divergence and beam shape to illuminate the field of view required and for the particular range finding, stray detecting or dazzling function.

In this arrangement, the controller 16 uses the range finder 18 in order to measure the range to target and then subsequently sets the power of the dazzle laser before it is switched on. Following this, the controller 16 continuously monitors the indication of range determined by the range finder 18 and adjusts the power of the dazzle laser 10 accordingly. This therefore ensures that the optimum laser intensity is generated at the target range, whilst ensuring that the power does not exceed that which would produce permanent ocular damage (retinal damage). As referred to above, the controller may control the effective strength of the laser beam by one or more of the following ways. The laser output power may be adjusted using laser power control 12. The divergence of the dazzle laser beam (since it is the intensity (laser power per unit area) which needs to be controlled at the target range) may be adjusted using an adjustable beam expander 14 at the dazzle laser exit for this purpose. The laser range finder beam is required to be roughly equal to or less than the divergence of the dazzle laser beam in order to ensure that the dazzle power is set according to the laser range finder target. A variable attenuator 15 may be used to attenuate the beam as required.

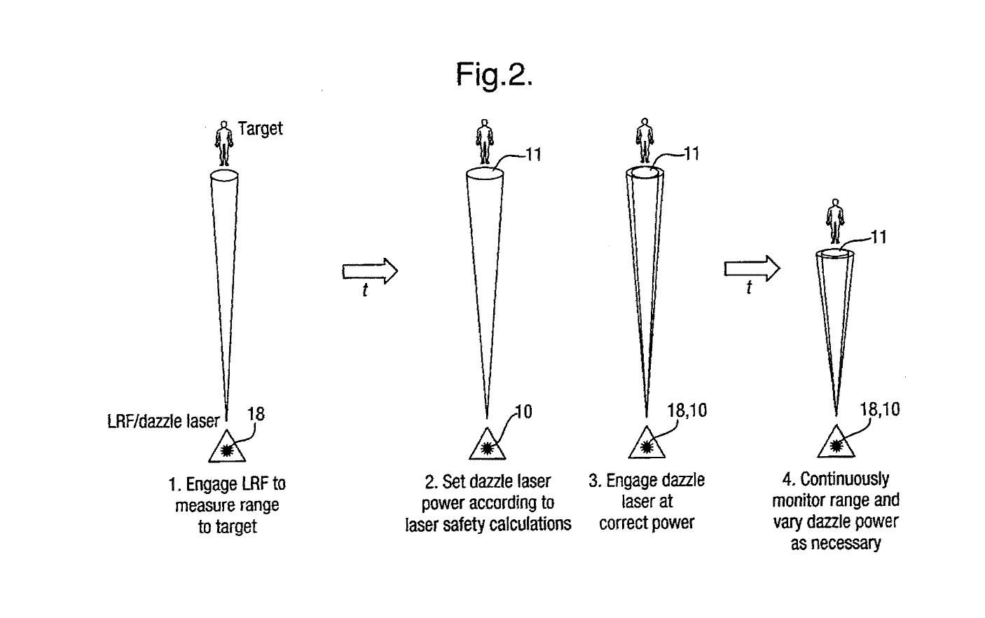

The dazzle process is illustrated schematically in FIG. 2. Thus initially the laser range finder 18 is used to measure the range to the required target. The controller 18 then uses this information to set power of the dazzle laser 10 according to laser safety calculations from a suitable look up table or the like. The dazzle laser 10 is then energised at the correct power momentarily to blind the target. The controller continuously monitors the range of the target and varies the dazzle power as necessary. The delay (t) between the laser range measurement acquisition and adjustment of the strength of the dazzle beam needs to be sufficiently short in order to prevent laser ocular overdose if the target moves towards the laser source.

Turning now to the anti-stray safety mechanism, given the laser intensity levels which could be present within 100 metres of the laser output aperture (particularly if the dazzle power is set for a target at, say, 1 km) it is advantageous to have a mechanism whereby the system will either reduce dazzle laser power or shut the laser off completely in the event of a third party wandering inadvertently into the dazzle laser beam or, where the user of the device is swinging the device around to follow a target, where the dazzle laser beam inadvertently approaches a third party. In a basic system the operator may be required to maintain awareness of the environment immediately surrounding that of the laser trajectory. However, in the arrangement described below, a safety mechanism is provided to remove this responsibility from the operator.

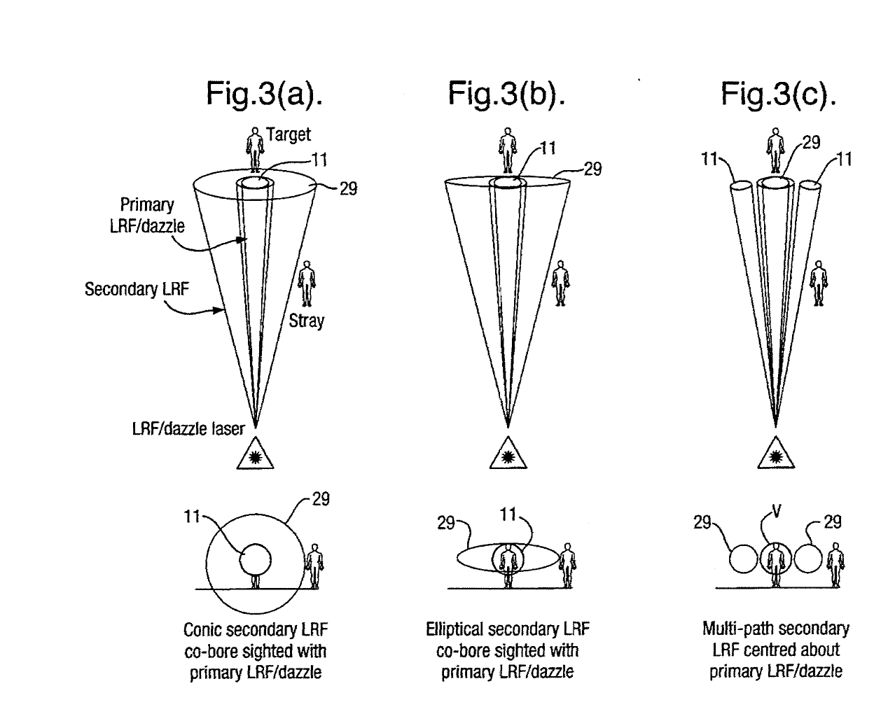

A stray detector module employing range finder technology is provided to monitor the periphery of the dazzle laser. The stray detection beam 29 is co-bore sited with the dazzle beam 11, or positioned closely adjacent, but has a divergence much larger than that of the dazzle beam and operates at a different wavelength in order to avoid cross talk. The divergence of the stray detection beam 29 produces a cone which detects objects which are adjacent but currently outside the dazzle beam, as illustrated in FIG. 3(a). While the dazzle laser 11 is operating, the stray detector continuously monitors the area immediately surrounding the dazzle laser 11. If the stray detector detects a secondary object moving towards the centre of its beam (i.e. the location of the dazzle laser), then the dazzle laser power is immediately reduced or shut down until such time that the stray secondary object has moved on, or that the stray secondary object has become the new target. The acquisition process may then continue as normal.

The beam shape of the secondary stray detection beam 29 may take various forms. In its simplest, a simple conic shape may be used (i.e. a Gaussian beam as in FIG. 3(a)) but it will be appreciated that such a beam will strike the ground after perhaps only a short distance. This may produce multiple ground reflections which may overload the stray detector receiver.

In a modification the stray detector beam emitter 28 incorporates a beam shaper 34. In one arrangement, rather than using optics to uniformly diffract the stray detector beam, a cylindrical lens (or wedge shaped optic) or a grating is used in order to diffract the beam non-uniformly. Thus the beam 29 is expanded in the horizontal plane but left essentially collimated (or at least of similar divergence to the dazzle beam) in the vertical plane. This produces a generally elliptical beam profile in the far-field. This is illustrated in FIG. 3(b). In another arrangement, shown in FIG. 3(c) a plurality of stray detectors 26 may be positioned either side of the primary dazzle beam 11. Functionally, this is similar to the elliptical beam of FIG. 3(b) but provides a greater range capability because diffracting the beam will spread the energy over a larger area leading to a drop in maximum range capability.

In a yet further embodiment, a single stray detector beam emitter could be used with a beam scanner 34 designed to continuously scan the pointing direction about the dazzle laser.

The divergence of the stray detector beam (or the angular deflection of the stray detector beam with respect to the primary dazzle beam) is determined by a trade off between the rate at which the combined system can determine that a stray (and not an inanimate object) has entered the field of view and set the dazzle laser power accordingly, and the reduction in maximum measurable range because of stray detector beam divergence. Thus the beam must be wide enough to detect a stray object in time to reduce dazzle power, but must be narrow enough to be useable at all practical ranges. In this respect it is advantageous that the region of highest dazzle power and therefore the region requiring the highest degree of power control is the range closest to the dazzle laser (0-100 metres). Beyond 100 to 200 metres, the change in dazzle power required for a target at, say, 500 metres compared to 800 metres, is very small.

The central control includes suitable tracking and discrimination software so that apparatus can discriminate between the background scene and the target or potential targets. Such software is well known to one skilled in the art and will not be described in detail here. Typically, such software may analyse a viewed scene to identify those elements that are moving in the scene. In addition, where the apparatus is designed to be moved itself the software will discount movement due to the change in viewing direction and still analyse for objects moving relative to the background scenery.

In a yet further embodiment, the controller may be adapted to allow a user to designate a target in the viewed scene and for the control unit to steer the dazzle beam to track a target. Again, such software algorithms are well known to those skilled in the art and will not be described in detail here. In this arrangement the detection axes of the range finger and the stray detector may be moved to follow the axis of the dazzle laser.

The device described herein may be used in a number of different applications but typically will be a portable unit. For example, the unit may be mounted on a rifle, a tripod or a vehicle.

1. A dazzle apparatus comprising:
a radiation source for emitting a dazzle beam of radiation towards a target to be dazzled, at a variable range;
a beam control system to control a strength of the dazzle beam in accordance with a range of said target to deliver to said radiation with sufficient intensity momentarily to dazzle a user; and
a stray detector for detecting approach of a secondary object towards said dazzle beam, or vice versa and, in response to such approach, for reducing the strength of or inhibit the dazzle beam.

2. A dazzle apparatus according to claim 1, wherein the radiation source emits a beam of laser radiation.

3. A dazzle apparatus according to claim 1, comprising:
a range finger for determining a range of a target.

4. A dazzle apparatus according to claim 3, wherein the range finder is a laser range finder.

5. A dazzle apparatus according to claim 4, wherein the range finder comprises:
a range finder receiver for detecting and processing radiation from said radiation source when reflected by said target thereby to determine a range of the target.

6. A dazzle apparatus according to claim 4, comprising:
a separate range finder source for emitting a range beam of radiation towards said target, wherein the range finder will detect and process radiation from said range beam of radiation when reflected by said target thereby to detect said range.

7. A dazzle apparatus according to claim 1, wherein the beam control system varies the strength of the dazzle beam by adjusting a power of the radiation source, and/or by adjusting a divergence of the dazzle beam.

8. A dazzle apparatus according to claim 1, wherein said beam control means comprises:
an attenuator for variably attenuating said dazzle beam to vary the strength of the radiation at said target.

9. A dazzle apparatus according to claim 1, wherein said stray detector comprises:
a stray detector source for emitting at least one stray detection beam to illuminate an area adjacent said dazzle beam; and
a stray detection receiver for detecting and processing radiation reflected by at least one secondary object to determine a position of the secondary object relative to the dazzle beam.

10. A dazzle apparatus according to claim 9, wherein said stray detector source comprises:
a beam shaper for shaping the stray detection beam with a flattened shape in which the beam divergence in one plane will be similar to that of the dazzle beam and will be significantly greater in a perpendicular plane.

11. A dazzle apparatus according to claim 9, wherein said stray detector source will emit a plurality of stray detection beams each disposed to illuminate a respective area adjacent said dazzle beam.

12. A dazzle apparatus according to claim 9, wherein said stray detector source is configured to scan one or more stray detector beams across an area adjacent the dazzle beam.

13. A dazzle apparatus according to claim 1, wherein said stray detector is configured to track a position of a secondary object and to predict a trajectory thereof, and said beam control system is configured to reduce the strength of, or inhibit, the dazzle beam when a predicted trajectory passes through, or within a preset distance of, the dazzle beam.

14. A dazzle apparatus according to claim 1, wherein the beam control system is configured to control an angular position of the dazzle beam, and comprises:
a target tracker which will, on acquisition or designation of a target, provide to said beam control system data to enable a controller to lock the dazzle beam on a target.
